(19) United States
(12) Patent Application Publication
(10) Pub. No.: US 2010/0118538 A1
(43) Pub. Date: May 13, 2010

(54) Adjustable light fixture with lens directed beam

(75) Inventor: Gregory L. Kay, Chicago, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Lightology, LLC.

(21) Appl. No.: 12/291,806

(22) Filed: Nov. 12, 2008

(51) Int. Cl. F21V 21/26

(52) U.S. Cl. 362/271; 362/269

(57) ABSTRACT

An adjustable lighting fixture for mounting on a power supplying track, including a mounting arm and a light housing. The mounting arm extends axially from an end mountable on a track and is adjustably rotatable about the axis. The light housing includes a housing base mounted to the mounting arm for adjustable rotation about a second axis substantially orthogonal to the mounting arm axis, and a housing portion for housing a light source. The housing portion includes a light opening through which light from the light source may pass and a lens mounting adapted to selectively mount a lens in the light opening to direct light from the light source in a selected path, where the housing portion with a mounted lens substantially enclose the light source and the housing portion is removably securable in a fixed orientation relative to the housing base.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward light fixtures, and particularly toward light fixtures providing highly controlled and directed lighting.

### BACKGROUND OF THE INVENTION AND TECHNICAL PROBLEMS POSED BY THE PRIOR ART

Light fixtures are, of course, used in many applications throughoutthe world to fundamentally provide more light to areas than would naturally occur based not only on the time of day and position of the sun, but also in shaded and enclosed areas throughout the day.

Such lighting not only involves basic illumination but also often includes spotlighting different areas for a variety of reasons, including not only aesthetics but also to highlight specific features and/or areas. Particularly in those installations having a need for highly controlled and directed spotlighting, for example, lenses have been used to direct the light shining from the fixture. Such lenses can not only focus the light, but can also shape it so that, for example, it will form a square spotlight, an oval spotlight, or virtually any desired shape. For example, museum displays may be highlighted by spotlights to not only make such areas more clearly viewable but also to draw viewers' attention to different areas in a particular manner by the shape of the light. Such lighting may also be used in theaters and with sales displays (e.g., in retail stores), as well as virtually any situation where such lighting is deemed to be desirable, including lighting in homes.

It should be appreciated, therefore, that particularly in installations where shaped spotlights are being used, it is important to be able to direct the light appropriately, which requires not only that the light fixture be appropriately oriented but also that the lens be appropriately oriented as well. U.S. Pat. No. 5,325,281 illustrates a light fixture which may have its direction adjusted through use of a pole (to facilitate making such adjustments when the fixture is located at a relatively inaccessible location such as a high ceiling). However, those light fixtures do not use lenses which require orientation beyond the direction in which the light beam is pointed. Such orientation with the required precision is often difficult if not impossible with many such fixtures, and U.S. Pat. No. 5,325,281 teaches nothing in that respect.

It should also be appreciated that the light source used in such fixtures will typically have to be changed with some degree of frequency. Additionally, it should be appreciated that since such fixtures can have a lens covering that light source, removal of the lens will be required in order to gain access to the area of the light source. However, while skilled personnel may be available to initially position the light fixture (e.g., in a new art museum display, a lighting technician may manipulate the fixture while working with an artist to choose the desired orientation of the spotlight), such personnel cannot reasonably be expected to be available to change the light source when necessary (e.g., when a light bulb burns out). More commonly, a regular custodian, who cannot be expected to be skilled in the art of lighting, will be expected to change light bulbs when they burn out.

Since the lens must typically be physically removed from the fixture in order to change the bulb, there is a serious risk that the lens will not be replaced appropriately after changing a bulb. For example, after the bulb is changed the fixture may be slightly moved to change the direction of the spotlight. Similarly, when lens is used to provide a non-circular shaped (e.g., elliptical, rectangular, square) spotlight which is oriented in a particular manner to provide a desired effect, there is a serious risk that the lens may be replaced in a different position so that the orientation of the shaped spotlight will no longer be as desired. A custodian typically cannot be reasonably expected to recognize whether the location and orientation of a spotlight remains as desired after replacing the bulb, nor can he be expected to be able to properly and precisely reorient the spotlight even if he were to recognize that the replaced bulb provides a spotlight which is not the same as previously provided.

The present invention is directed toward overcoming one or more of the problems set forth above.

### SUMMARY OF THE INVENTION

In one aspect of the present invention, an adjustable lighting fixture for mounting on a support is provided, including a mounting arm and a light housing. The mounting arm extends axially from an end mountable on a support and is adjustably rotatable about the axis. The light housing includes a housing base mounted to the mounting arm for adjustable rotation about a second axis substantially orthogonal to the mounting arm axis, and a housing portion for housing a light source. The housing portion includes a light opening through which light from the light source may pass and a lens mounting adapted to selectively mount a lens in the light opening to direct light from the light source in a selected path, where the housing portion with a mounted lens substantially enclose the light source and the housing portion is removably securable in a fixed orientation relative to the housing base.

In one form of this aspect of the invention, the housing portion and housing base are removably securable together, with a first cylindrical lip around the housing base and a second cylindrical lip around the housing portion, where one of the cylindrical lips receivable in the other. Annular grooves in the two lips face one another and axially overlap when the housing portion is removably secured to the housing base. A key connection between the cylindrical lips ensures that they are securable together in only one angular orientation and a C-spring is received in the grooves. In a still further form, the C-spring is biased into one of the grooves when an axial force is applied between the housing portion and the housing base.

In another form of this aspect of the present invention, the housing portion and housing base are removably securable together by a key defining a selected orientation therebetween and a plurality of detent connections between the housing base and the housing portion. In a further form, the housing base includes a substantially flat base portion, the housing portion is defined by walls extending substantially perpendicular to the base portion and, when secured together, the base portion is positioned inside of the walls and the detent connections extend outwardly from the edge of the flat base portion toward the walls. In a still further form, the flat base portion edge is irregularly shaped whereby the housing portion may be secured thereto in only one orientation.

In still another form of this aspect of the present invention, which may be used with either of the above described forms, the lens mounting includes an inner thread inside the housing portion adapted to engage an outer thread of a lens, whereby the lens may be selectively threaded in the housing portion inner thread to selectively position the lens axially and angularly relative to the housing portion to direct light from the light source in a selected path, and a lock is provided to secure a lens in the selected threaded position relative to the housing portion. In a further form, a lip extends inwardly on the interior of the housing portion, a first cylindrical member has a radially projecting flange on one side and a portion extending axially from the flange with threaded portions on its inner and outer surfaces, a second cylindrical member has a threaded portion on its inner surface, whereby the second cylindrical member threaded portion is threaded onto the outer surface threaded portion of the first cylindrical member with the inwardly extending housing portion lip between the first cylindrical member flange and the second cylindrical member, wherein the inner surface threaded portion of the first cylindrical member is the housing portion inner thread. According to a still further form, the lock includes a first lock for securing the lens relative to the first cylindrical member, and a second lock for securing the second cylindrical member relative to the housing portion inwardly extending lip.

In yet another form of this aspect of the present invention, a drive shaft is rotatable about the orthogonal axis relative to the mounting arm, with the drive shaft fixed on one end to the housing portion for rotation therewith and having a gear fixed on its other end, and a worm extends axially in the mounting arm with the worm drivably engaging the drive shaft and having a drivable end exposed at the mounting arm other end. In a further form, the mounting arm and the light housing have mating cylindrical portions mounted together with the drive shaft having a diameter smaller than the cylindrical portion, and a power line extends through the cylindrical portions in the radial space between the drive shaft and the inner walls of the cylindrical portions. In a still further form, the light housing includes a cylindrical opening coaxial with the housing cylindrical portion, the cylindrical opening having a smaller diameter than the housing cylindrical portion, with an arcuate slot defined between the cylindrical opening and the housing, and the power line extending through the arcuate slot into the housing.

According to another form of this aspect of the present invention, the support is a power supplying track, and a U-shaped mounting member with legs is adapted to fit over the track, wherein the end of the legs are securable to the mounting arm first end. In a further form, the mounting member legs and the mounting arm track end include interengageable threaded portions.

According to still another form of this aspect of the present invention, the support is a power supplying track, and an insulated power line extends inside the fixture from the mounting arm first end where it is adapted to engage one side of a power circuit on the track to an insulated base in the light housing, wherein the light housing and mounting arm connect the insulated base to the other side of the power circuit on the track.

According to yet another form of this aspect of the present invention, the mounting arm and the light housing have mating cylindrical portions mounted together, and scale indicators on the cylindrical portions indicate the rotated position of the drive shaft around the orthogonal axis.

In another aspect of the present invention, an adjustable lighting fixture for mounting on a support is provided, including a mounting arm, a light housing and a drive. The mounting arm extends axially from an end mountable on a support and is adjustably rotatable about the axis. The light housing includes a housing base mounted to the mounting arm for adjustable rotation about a second axis substantially orthogonal to the mounting arm axis, and a housing portion for housing a light source. The housing portion includes a light opening through which light from the light source may pass and a lens mounting adapted to selectively mount a lens in the light opening to direct light from the light source in a selected path. The lens mounting includes an inner thread inside the housing portion adapted to engage an outer thread of a lens, whereby the lens may be selectively threaded in the housing portion inner thread to selectively position the lens axially and angularly relative to the housing portion to direct light from the light source in a selected path, and a lock for securing a lens in the selected threaded position relative to the housing portion. The housing portion and a mounted lens substantially enclose the light source, and the housing portion is removably securable in a fixed orientation relative to the housing base. The drive adjustably rotates the housing base about the second axis, and includes a drive shaft rotatable about the second axis relative to the mounting arm with the drive shaft fixed on one end to the housing portion for rotation therewith and having a gear fixed on its other end, and also includes a worm extending axially in the mounting arm, the worm drivably engaging the drive shaft and having a drivable end exposed at the mounting arm second end.

In one form of this aspect of the invention, the housing portion and housing base are removably securable together, with a first cylindrical lip around the housing base and a second cylindrical lip around the housing portion, where one of the cylindrical lips receivable in the other. Annular grooves in the two lips face one another and axially overlap when the housing portion is removably secured to the housing base. A key connection between the cylindrical lips ensures that they are securable together in only one angular orientation and a C-spring is received in the grooves. In a still further form, the C-spring is biased into one of the grooves when an axial force is applied between the housing portion and the housing base.

In another form of this aspect of the present invention, the housing portion and housing base are removably securable together by a key defining a selected orientation therebetween and a plurality of detent connections between the housing base and the housing portion. In a further form, the housing base includes a substantially flat base portion, the housing portion is defined by walls extending substantially perpendicular to the base portion and, when secured together, the base portion is positioned inside of the walls and the detent connections extend outwardly from the edge of the flat base portion toward the walls. In a still further form, the flat base portion edge is irregularly shaped whereby the housing portion may be secured thereto in only one orientation.

In still another form of this aspect of the present invention, which may be used with either of the above described forms, a lip extends inwardly on the interior of the housing portion, a first cylindrical member has a radially projecting flange on one side and a portion extending axially from the flange with threaded portions on its inner and outer surfaces, a second cylindrical member has a threaded portion on its inner surface, whereby the second cylindrical member threaded portion is threaded onto the outer surface threaded portion of the first cylindrical member with the inwardly extending housing portion lip between the first cylindrical member flange and the second cylindrical member, wherein the inner surface threaded portion of the first cylindrical member is the housing portion inner thread. According to a still further form, the lock includes a first lock for securing the lens relative to the first cylindrical member, and a second lock for securing the second cylindrical member relative to the housing portion inwardly extending lip.

According to still another form of this aspect of the present invention, the support is a power supplying track, and an insulated power line extends inside the fixture from the mounting arm first end where it is adapted to engage one side of a power circuit on the track to an insulated base in the light housing, wherein the light housing and mounting arm connect the insulated base to the other side of the power circuit on the track.

According to yet another form of this aspect of the present invention, the mounting arm and the light housing have mating cylindrical portions mounted together, and scale indicators on the cylindrical portions indicate the rotated position of the drive shaft around the orthogonal axis.

### BRIEF DESCRIPTION OF THE DRAWINGS

FIG. 1 is a perspective view of a light fixture according to a first embodiment of the present invention as mounted on a track;

FIG. 2 is a perspective view of a light fixture according to a second embodiment of the present invention;

FIG. 3 is a partially exploded view of the light fixture of FIG. 1 illustrating the structure for adjusting the position of the fixture;

FIG. 4 is a partial cross-sectional view of the light fixture of FIG. 2;

FIG. 5 is a partial cross-sectional view of the light fixture of FIG. 1;

FIGS. 6 and 7 are perspective partially broken away views of a portion of the light fixtures of the present invention;

FIGS. 8 and 9 are perspective views of the mounting arm of a light fixture according to the present invention as variously mounted to a track;

FIG. 10 is a perspective partially broken view illustrating a connection of the light fixture to a track;

FIG. 11 is a partial cross-sectional view of a third light fixture embodying aspects of the present invention, with a cylindrical shaped housing;

FIG. 12 is a partial cross-sectional view of the FIG. 11 fixture, with the housing and lens mount exploded;

FIG. 13 is a top, partially cut-away view of the square light fixture of FIG. 2 illustrating the connection of the light housing portion to the light housing base;

FIG. 14 is a partial cross-sectional view of a fourth light fixture embodying aspects of the present invention, with a spherical shaped housing, with FIG. 14a showing enlarged detail of the C-spring connection;

FIG. 15 is a partial cross-sectional view of the FIG. 14 fixture, with the housing base, C-spring and housing portion exploded, with FIG. 15a showing enlarged detail of the area connected in FIG. 14a; and

FIG. 16 is an exploded perspective view of the connection of the housing base and removable housing portion with a C-spring.

### DETAILED DESCRIPTION OF THE INVENTION

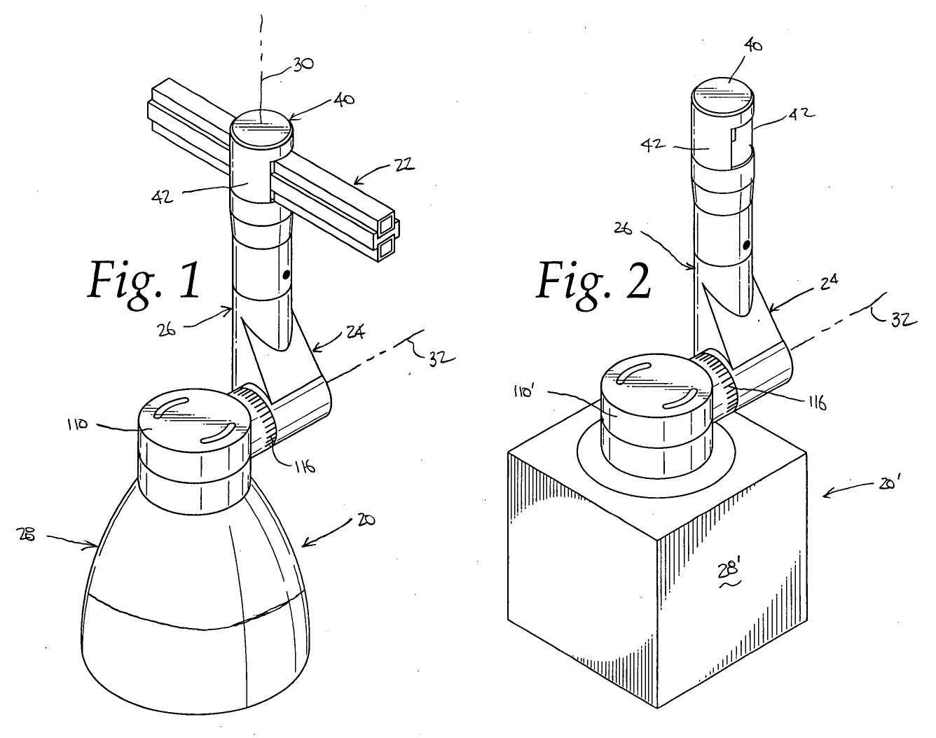

A first light fixture 20 according to the present invention is shown in FIG. 1 as mounted on a track 22. It should be appreciated that while mounting of the fixture 20 on a track 22 can be advantageous, many of the aspects of the present invention may also be obtained no matter what the support on which the fixture is mounted.

The fixture 20 includes an adjustable mount 24 with a generally axial mounting arm 26 for a light housing 28. The mounting arm 26 may be adjustably rotated about its axis 30 as further described below, and the light housing 28 may be adjustably rotated about an axis 32 normal or orthogonal to the arm axis 30 as also further described below. It should be appreciated, therefore, that the light housing 28 may be selectively pointed in virtually any direction so as to generally direct light from a light source inside the housing 28 in a desired direction, as also described in greater detail hereafter.

A U-shaped mounting member 40 includes downwardly depending legs 42 which are adapted to fit over the track 22 and to be suitably secured to the top of the mounting arm 26, as described hereafter, to secure the fixture 20 to the track 22 for sliding therealong to place the light fixture 20 in the desired position on the track 22. It should be appreciated, however, that still other structures for securing the mounting arm 26 to a track 22 may be advantageously used within the scope of at least some aspects of the present invention. It should further be appreciated that light fixtures embodying aspects of the present invention may also be used with lighting systems other than track lighting.

FIG. 2 illustrates a second light fixture 20′ wherein components identical to those in FIG. 1 are given the same reference numeral. This fixture 20′ has a similar adjustable mount 24 permitting adjustable rotation about axes 30, 32 which are generally orthogonal to each other.

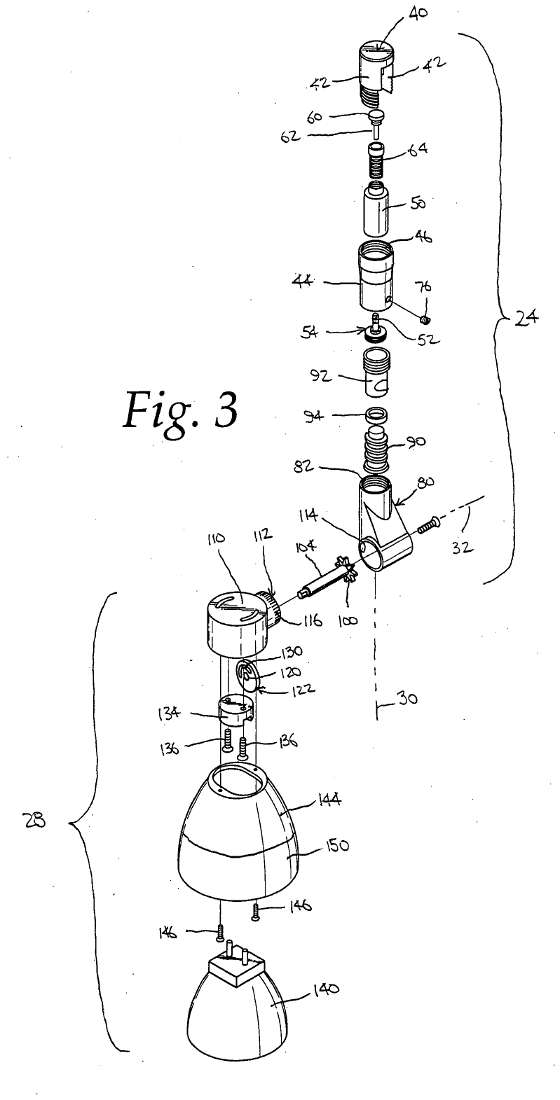

FIG. 3 illustrates an exploded view of one adjustable mount 24 which may be used with the present invention.

The mount 24 includes an outer connector body 44 with an inner thread 46 which may be removably secured to the mounting member 40 by screwing the threaded bottom portion of the mounting member legs 42 into the inner thread 46 of the outer connector body 44.

An inner connector body 50 is rotatably received inside the outer connector body 44, and suitably secured thereto by suitable securement (for example, a threaded connection) to the upper end of the shaft 52 of a connector adapter 54 which extends through a reduced diameter portion (not shown) in the bottom of the outer connector body 44.

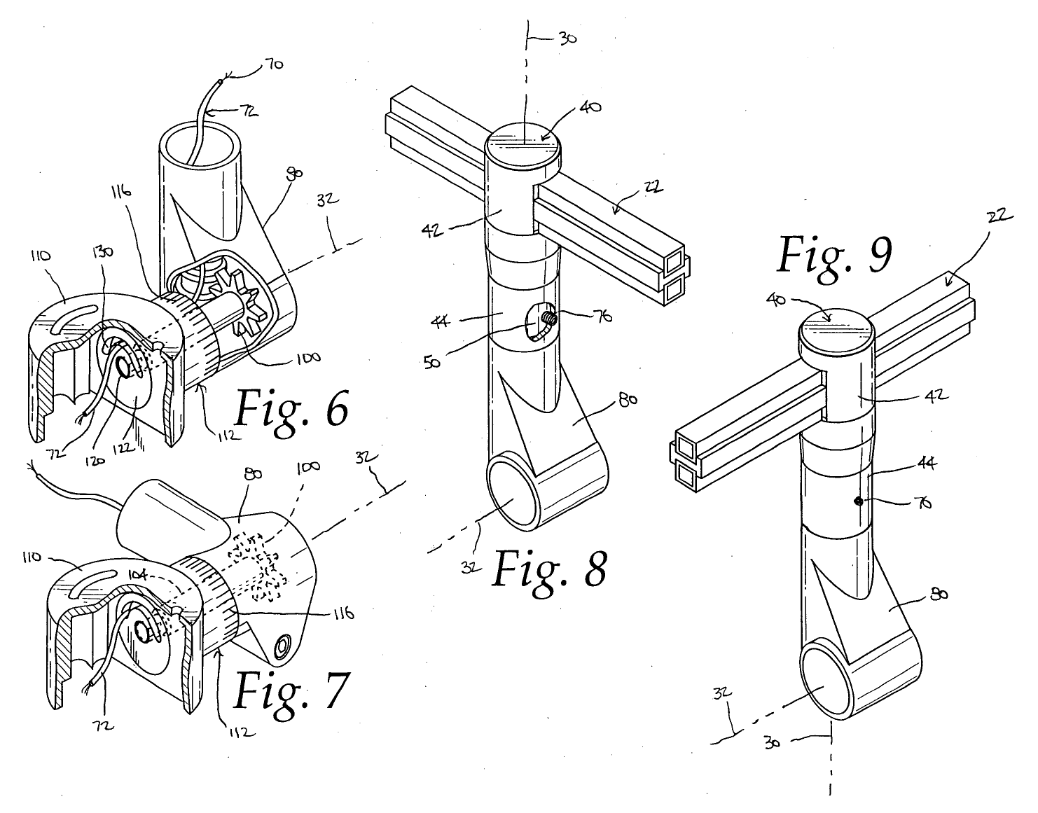

A suitable connector 60 for one side of the light power circuit is also provided in the top of the mounting arm 24, and includes a bottom stem 62 which may be received inside a threaded nylon isolator 64 which itself is received inside the inner connector body 50. The exposed end 70 of an insulated wire 72 (not shown in FIG. 3, but shown in FIGS. 6-7) is suitably secured in the isolator 64 in conductive contact with the connector stem 62. The insulated wire 72 extends up through a central passageway through the various components of the mounting arm 24 whereby the wire 72 defining that side of the power circuit is advantageously retained inside the fixture 20, extending from the connector 60 to the inside of the light housing 28 as described in more detail hereafter.

The outer metallic conductive components of the fixture may define the other side of the power circuit when used with low voltage light systems, such as 12 volt track lighting. However, it should be understood that light fixtures according to the present invention may be used with different track structures and different associated connectors. Further, at least some aspects of the present invention may also be obtained when used with supporting/power supplying structures other than tracks.

A set screw 76 extending through the outer connector body 44 may be tightened to engage the outer surface of the inner connector body 50 to secure them together in a selected rotational position about the generally vertical axis 30 (see FIGS. 8-9).

A gear body housing 80 is suitably secured to the mounting arm 24, as by engagement of an inner thread 82 with an outer thread on the head of the connector adapter 54.

A worm 90 is secured in the gear body housing 80, beneath a worm gear lock 92 also threaded inside the worm gear housing 80, and a worm gear washer 94. The bottom of the worm 90 includes a suitable irregular recess which may be accessed through an opening 96 in the gear body housing 80 (see FIG. 7) for engagement by a suitable tool (e.g., with an Allen wrench type attachment) to rotate the worm 90.

A gear 100 is also suitably secured in the gear body housing 80 (e.g., by a screw 102 through the side of the gear body housing 80 and longitudinally in the gear 100) so as to be rotatable around the orthogonal axis 32. The gear 100 is drivably engaged with the worm 90 (see FIG. 6) whereby rotation of the worm 90 will cause the gear 100 to rotate about its axis 32.

The distal end of the gear shaft 104 is suitably fixed to a light housing base 110 which includes a cylindrical portion 112 which suitably mates with a cylindrical opening 114 in the gear body housing 80. A suitable scale 116 (e.g., angular marks) may be provided at the connection to indicate the relative rotational positions. This may be used not only to record the proper desired orientation of a particular fixture 20, but may also be used to facilitate related orientation of multiple fixtures 20 in settings where, for example, it is desired to have multiple fixtures oriented in the same direction.

It should be appreciated that the fixture 80 thus provides a pathway through the mounting arm 24, the gear body housing 80, and the housing base cylindrical portion 112 into the housing base 110 for the insulated wire 72, to both protect the wire 72 and for aesthetic purposes as illustrated in FIGS. 6-7. For example, the distal end of the gear shaft 104 may be suitably secured (e.g., by a set screw) in a central opening 120 of a mounting plate 122 suitably secured at the inner end of the base cylindrical portion 112. An arcuate slot 130 through the mounting plate 122 and around its central opening 120 allows passage of the wire 72 into the housing base 110 where the wire end may be secured to an insulated socket structure 134 (e.g., by screws 136). The socket structure 134 is adapted to secure a suitable light source (e.g., light bulb 140), with the power circuit running from one side of the track 22, through the wire 72, then through the light bulb 140 to generate the desired light, then through the metal housing components of the fixture 20 to the other side of the track 22.

A two prong MR 16 lamp is illustrated as one type of bulb which would be suitable for this fixture 20. However, it should be appreciated that still other bulbs/lamps could be used within the scope of the present invention, with suitable sockets or other attachments provided in the housing base 110 to accommodate such bulbs.

Advantageously according to the present invention, the light housing 28 includes a housing base 110 which is securely connected to the mounting arm 24 for rotation about the orthogonal axis 32. The housing base 110 also may include another housing section 144 fixed thereto, as by screws 146.

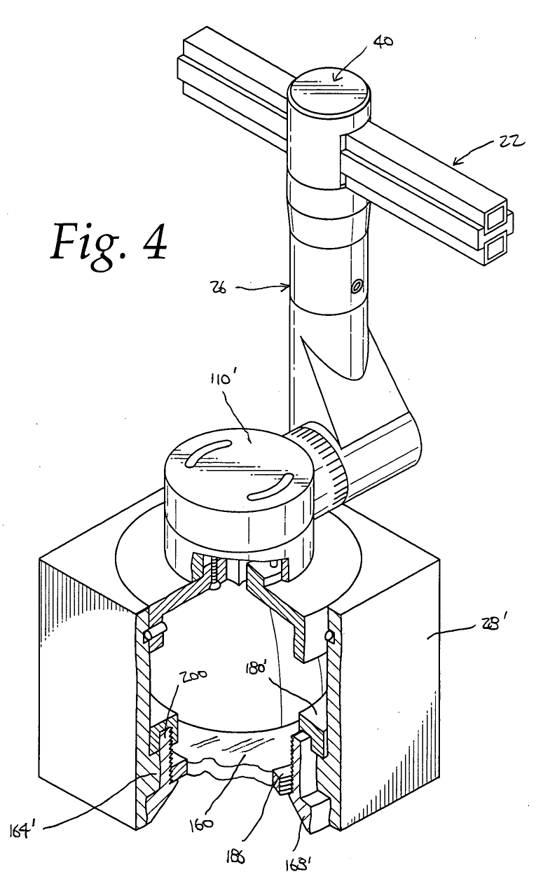

The light housing 28 also includes a housing portion 150 which is adapted to securely and precisely mount a spread lens 160 (see FIGS. 4, 5, 11 and 12) over the lamp 140 as described in greater detail below. The spread lens 160 may advantageously be adapted to direct light from the lamp 140 into a beam having a selected shape (e.g., such as an oval or a square beam). Thus, the fixture 20 may be used in museum settings, etc. such as described herein, where unique and precisely selected lighting may be provided for areas and displayed objects. It should be appreciated that positioning the fixture 20 in selected positions around the axes 30, 32 will allow the beam to generally be directed in precisely the desired direction.

Moreover, in accordance with the present invention, the housing portion 150 may not only be precisely mounted so as to also precisely mount the lens 160 to further direct and shape the beam as desired, but that housing portion 150 may be readily removed from the housing base 110 as required to change a light bulb 140 in the housing 28 and then replaced after the bulb 140 is changed so as to be returned in the precisely required position previously established.

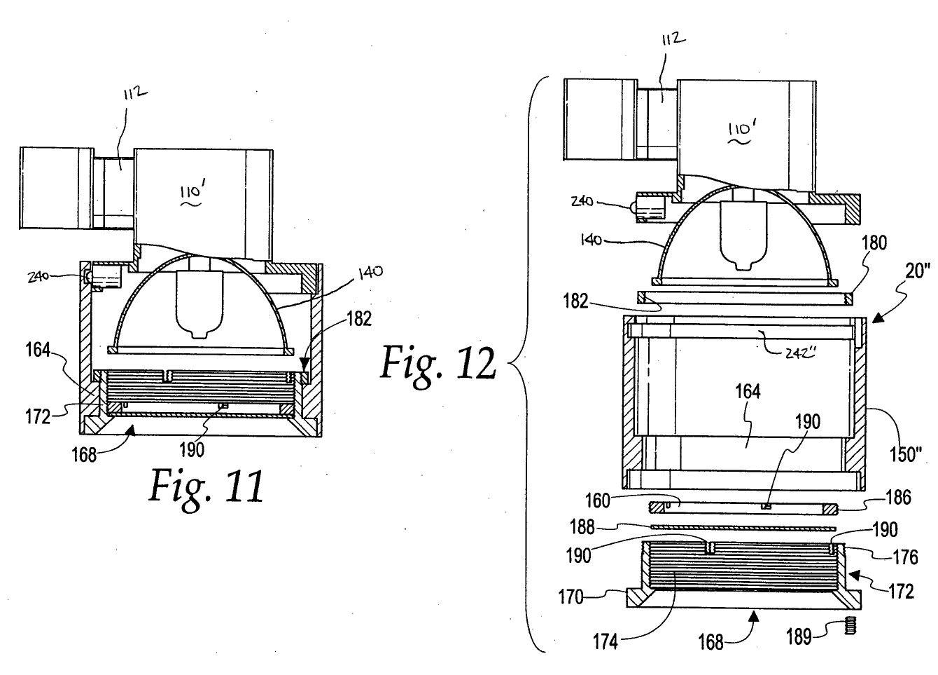

FIGS. 4, 5, 11 and 12 illustrate the advantageous mounting of the lens 160. Specifically, referring first to FIGS. 11 and 12 (which relate to a third fixture 20″ having a cylindrical shaped housing 28), the interior of the housing portion 150″ includes a lip 164 extending inwardly. A first cylindrical member 168 includes a radially projecting flange 170 and an axially extending portion 172 with an inner thread 174 and an outer thread 176 on at least its upper end. A second cylindrical member 180 has an inner thread 182 which may be threaded over the first cylindrical member outer thread 176 to secure the two over the housing portion lip 164.

The lens 160 is adjustably located in the first cylindrical member 168 so that it may be both axially and rotationally adjusted. Specifically, the lens 160 may advantageously be supported in a threaded mount 186 which may be positioned by screwing it into the inner thread 174 of the first cylindrical member 168. The threaded mount 186 may be advantageously frictionally retained in position, or suitable locks for securing the lens 160 therein may be used (e.g., set screws) or spacers 188 may also be provided. Similarly, locks such as set screws 189 may be used to secure the cylindrical members 168, 180 in place. Further, recesses 190 may be provided in the cylindrical members 168, 180 and threaded mount 186 to allow use of suitable spanner wrenches or the like to screw the components together.

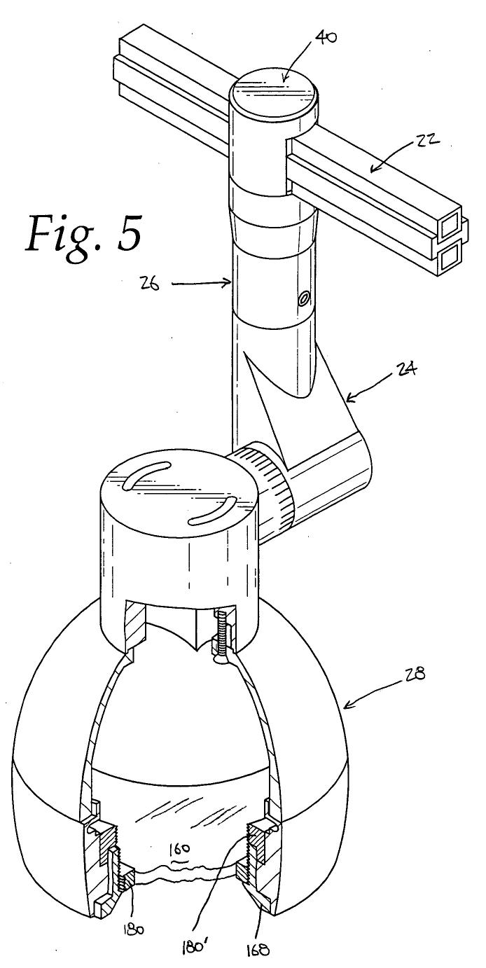

Referring now to FIG. 4, a similar light mounting may be provided with a square housing 28′. In this alternate embodiment, the upper cylindrical member 180′ may receive the lower cylindrical member 168 in a downwardly open annular groove 200, with the groove 200 having a radially outwardly facing thread which may be engaged with the inner thread 174 of the first cylindrical member 168′ (thereby negating the need for an outer thread on the first cylindrical member 168′. Though the outer housing 28′ is square, an inner cylindrical lip 164′ is provided to facilitate locating and adjusting the lens 160 therein. FIG. 5 illustrates still another variation of a light mounting, wherein the upper (second) cylindrical member 180′ includes an inwardly extending flange with an inner thread, thereby extending the axial distance through which the lens 160 may be mounted. Of course, it should be appreciated that still other lens mount variations could be provided within this aspect of the present invention.

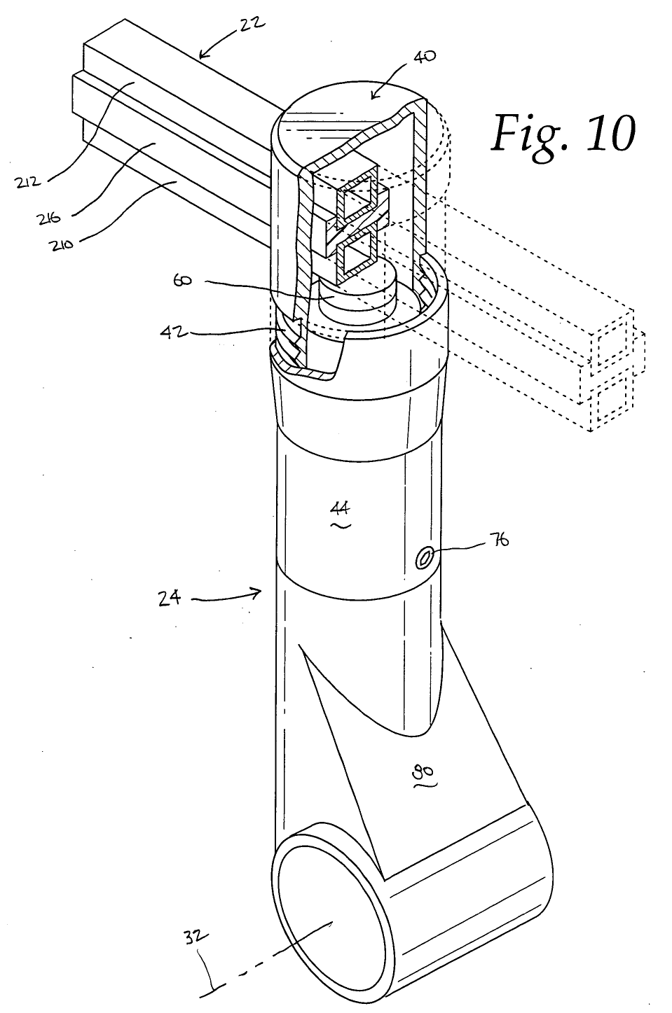

FIG. 10 illustrates one suitable connection of the fixture mounting arm 24 to the track 22. Specifically, the connector 60 projects up above the upper lip of the outer connector body 44 so that it engages the bottom track member 210 with the mounting member 40 pressed against the upper track member 212 when screwed tightly into the outer connector body 44. An insulated separator 216 is between the track members 210, 212. Thus, it should be appreciated that the wire side of the power circuit is connected to the bottom track member 210 via the connector 60, whereas the other side of the power circuit (through the outer housing of the fixture 20) engages the upper track member 212 via the mounting member 40 with the other side of the power circuit maintained spaced from the lower track member by the insulated separator 216. Of course, as previously mentioned, the present invention could be used with different tracks, different mounts for securing to the track, or even different base mounts which are not used with tracks at all.

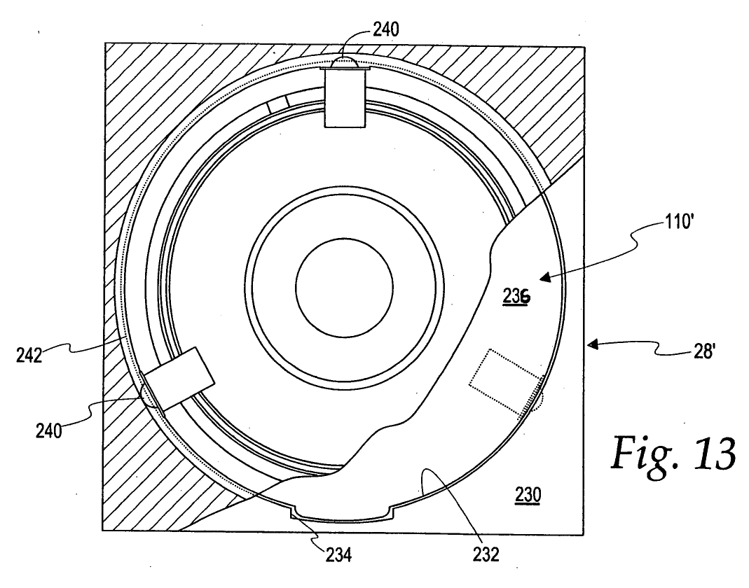

FIG. 13 illustrates one structure for removably securing the square light housing portion 28′ from the housing base 110′. Specifically, the top surface 230 of the light housing portion 28′ includes an irregularly shaped opening 232 (e.g., including one recess 234 in an otherwise circular opening, with the recess 234 defining a key) which may be aligned in only one orientation with the similarly irregularly shaped outwardly projecting flange 236 of the housing base 110′. Spherical detents 240 are biased outwardly from the outer surface of the base outwardly projecting flange 236 so as to extend into an inwardly open annular groove 242 below the top surface 230 of the housing portion 28′.

It should thus be appreciated that when a light bulb 140 burns out in the light fixture 20′ having the structure illustrated in FIGS. 2, 4 and 13, a custodian may simply grasp the square housing 28′ and pull it down and off of the housing base 110′ (as the detents 240 will be pushed in clear of the housing upper surface 230 when the housing 28′ is pulled down). The custodian may then easily gain access to the light bulb 140 to remove it, and to replace it with a new bulb 140, after which he can return the square housing 28′ by aligning its irregularly shaped opening 232 with the irregularly shaped flange 236 of the housing base 110′ and simply snap it back into place (with the detents 240 again in the annular groove 242 of the housing portion 28′).

Particularly, it should be noted that when a bulb is changed, even though the lens was necessarily removed in order to be able to gain access to the bulb, the lens 160 is reliably replaced in the same position as it was when the light was first position by a lighting technician (working, possibly, in conjunction with an artist). Therefore, the fixture 20′ will provide the same shaped beam as previously set without the less skilled custodian having to worry about resetting the lens and/or fixture to some particular desired orientation which may not even be known by the custodian.

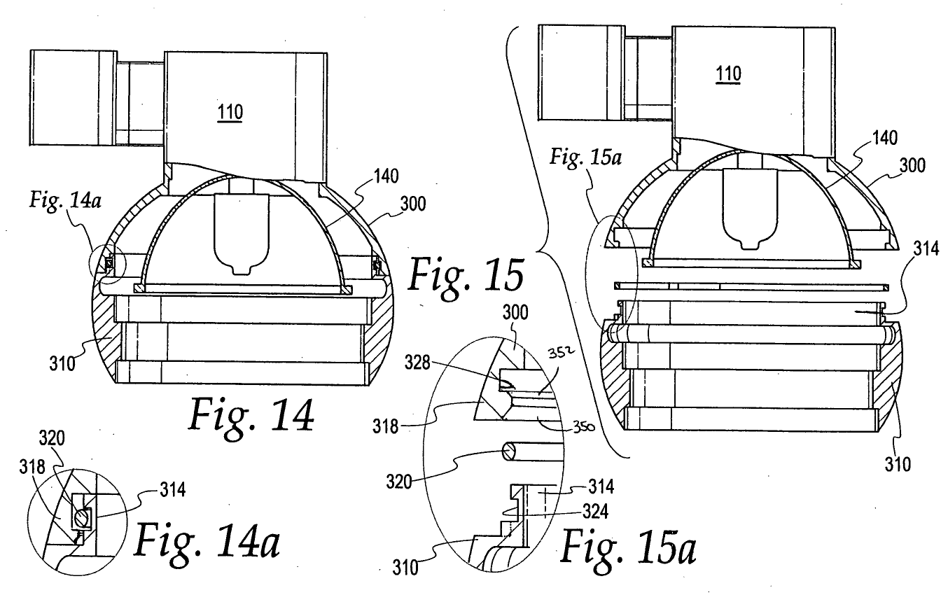

FIGS. 14 and 15 illustrate yet another structure for removably securing a portion of the light housing 28″ from the housing base 110″. Specifically, in this structure, the housing 28″ is generally spherical with a portion 300 of the spherical housing 28″ being a fixed part of the housing base 110″ and a removable housing portion 310. The removable housing portion 310 includes an inner cylindrical lip 164″ for mounting of the lens 160 as previously described, though the lens 160 and its mounting structure are omitted from FIGS. 14 and 15 for clarity.

As illustrated in the exploded view of FIGS. 15 and 15a, the removable housing portion 310 includes a cylindrical lip 314 and the housing base portion 300 includes a cylindrical lip 318 within which the removably housing portion lip 310 may be received. A C-spring 320 is receivable in facing grooves 324, 328 in each of the lips 314, 318 whereby when snapped together the housing base portion 300 and the removable housing portion 310 will be retained together by the interference overlapping of C-spring 320 with the top of groove 324 and the bottom of groove 328 as seen in FIG. 14a.

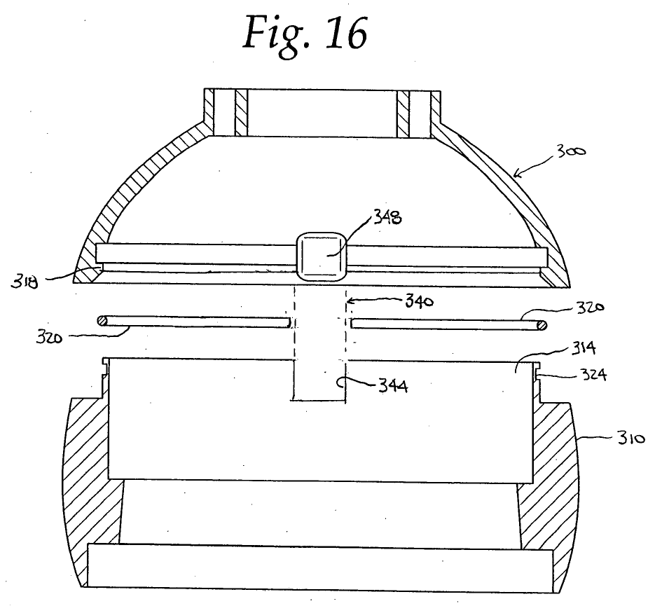

A key connection 340 (see FIG. 16) ensures proper rotational alignment of the removable housing portion 310 with the housing base portion 300. Specifically, the key 340 consists of a slot 344 in the inner lip 314 and an inwardly projecting key 348 on the outer lip 318, with the key 348 ensuring that the removable housing portion 310 can only be aligned in a single angular orientation (with its slot 344 aligned with the key 348). Thus, as with the FIG. 13 connection, when a bulb is changed and the lens is necessarily removed in order to be able to gain access to the bulb, the lens 160 is reliably replaced in the same position as it was when the light was first positioned. Therefore, the fixture 20′ will provide the same shaped beam as previously set without the less skilled custodian having to worry about resetting the lens and/or fixture to some particular desired orientation which may not even be known by the custodian.

As also seen in FIG. 16, it should be appreciated that the gap in the C-spring 320 should be slightly greater than the width of the key 348, and that the inner diameter of the groove 324 plus twice the diameter of the body of the C-spring 320 (i.e., the diameter of the material of the C-spring 320) be no greater than the inner diameter of bottom of the lip 318 of the housing base portion 300. Similarly, the depth of the groove 324 should advantageously be about the diameter of the body of the C-spring 320. As a result, the housing potion 310 and housing base portion 300 may be removed by pulling them apart, whereby the pulling force will cause the C-spring 320 to squeeze together into the groove 324 so that it may clear the bottom portion of the lip 318 of the housing base portion 300. The housing base portion 300 and removable housing portion 310 can similarly be snapped back together by pushing them together, with that force also causing the C-spring 320 to squeeze together into the groove 324 so that it may clear the bottom portion of the lip 318 of the housing base portion 300.

Suitable tapers 350, 352 (see FIG. 15a) may also be provided around the bottom inner edge of the lip 318 which cams with the round C-spring 320 to facilitate squeezing together of the C-spring 320 when the removable housing portion 310 and housing base portion 300 are pushed together or pulled apart (with the C-spring 320 in the groove 324 of the removable housing portion lip 314).

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. An adjustable lighting fixture for mounting on a support, comprising:
a mounting arm extending substantially axially between a first end adapted to be mounted on a support and a second end, said arm being adjustably rotatable about its axis;
a light housing including
a housing base mounted to said mounting arm adjacent said mounting arm second end for adjustable rotation about a second axis substantially orthogonal to said mounting arm axis, and
a housing portion for housing a light source, including
a light opening through which light from the light source may pass, and
a lens mounting adapted to selectively mount a lens in said light opening to direct light from the light source in a selected path,
wherein said housing portion and a mounted lens substantially enclose the light source, and said housing portion is removably securable in a fixed orientation relative to said housing base.

2. The light fixture of claim 1, wherein said housing portion and housing base are removably securable together by:
a first cylindrical lip around said housing base and a second cylindrical lip around said housing portion, one of said cylindrical lips being receivable in the other of said cylindrical lips;
a first annular groove in said first cylindrical lip and a second annular groove in said second cylindrical lip, wherein said annular grooves face one another and axially overlap when said housing portion is removably secured to said housing base;
a key connection between said cylindrical lips whereby said one cylindrical lip is receivable in said other cylindrical lip in only one angular orientation; and
a C-spring received in said grooves.

3. The light fixture of claim 2, wherein said C-spring is biased into one of the grooves when an axial force is applied between said housing portion and said housing base.

4. The light fixture of claim 2, wherein said lens mounting comprises:
an inner thread inside said housing portion adapted to engage an outer thread of a lens, whereby said lens may be selectively threaded in said housing portion inner thread to selectively position the lens axially and angularly relative to said housing portion to direct light from the light source in a selected path; and
a lock for securing a lens in the selected threaded position relative to said housing portion.

5. The light fixture of claim 4, wherein said lens mounting further comprises:
a lip extending inwardly on the interior of said housing portion;
a first cylindrical member having a radially projecting flange on one side and a portion extending axially from the flange with threaded portions on its inner and outer surfaces;
a second cylindrical member having a threaded portion on its inner surface, whereby said second cylindrical member threaded portion is threaded onto the outer surface threaded portion of the first cylindrical member with said inwardly extending housing portion lip between said first cylindrical member flange and said second cylindrical member;
wherein said inner surface threaded portion of the first cylindrical member is said housing portion inner thread.

6. The light fixture of claim 5, wherein said lock comprises:
a first lock for securing the lens relative to said first cylindrical member; and
a second lock for securing said second cylindrical member relative to said housing portion inwardly extending lip.

7. The light fixture of claim 1, wherein said housing portion and housing base are removably securable together by a key defining a selected orientation therebetween and a plurality of detent connections between said housing base and said housing portion.

8. The light fixture of claim 7, wherein:
said housing base includes a substantially flat base portion;
said housing portion is defined by walls extending substantially perpendicular to said base portion; and
when secured together, said base portion is positioned inside of said walls and said detent connections extend outwardly from the edge of said flat base portion toward said walls.

9. The light fixture of claim 8, wherein said flat base portion edge is irregularly shaped whereby said housing portion may be secured thereto in only one orientation.

10. The light fixture of claim 7, wherein said lens mounting comprises:
an inner thread inside said housing portion adapted to engage an outer thread of a lens, whereby said lens may be selectively threaded in said housing portion inner thread to selectively position the lens axially and angularly relative to said housing portion to direct light from the light source in a selected path; and
a lock for securing a lens in the selected threaded position relative to said housing portion.

11. The light fixture of claim 10, wherein said lens mounting further comprises:
a lip extending inwardly on the interior of said housing portion;
a first cylindrical member having a radially projecting flange on one side and a portion extending axially from the flange with threaded portions on its inner and outer surfaces;
a second cylindrical member having a threaded portion on its inner surface, whereby said second cylindrical member threaded portion is threaded onto the outer surface threaded portion of the first cylindrical member with said inwardly extending housing portion lip between said first cylindrical member flange and said second cylindrical member;
wherein said inner surface threaded portion of the first cylindrical member is said housing portion inner thread.

12. The light fixture of claim 11, wherein said lock comprises:
a first lock for securing the lens relative to said first cylindrical member; and
a second lock for securing said second cylindrical member relative to said housing portion inwardly extending lip.

13. The light fixture of claim 1, wherein said lens mounting comprises:
an inner thread inside said housing portion adapted to engage an outer thread of a lens, whereby said lens may be selectively threaded in said housing portion inner thread to selectively position the lens axially and angularly relative to said housing portion to direct light from the light source in a selected path; and
a lock for securing a lens in the selected threaded position relative to said housing portion.

14. The light fixture of claim 13, wherein said lens mounting further comprises:
a lip extending inwardly on the interior of said housing portion;
a first cylindrical member having a radially projecting flange on one side and a portion extending axially from the flange with threaded portions on its inner and outer surfaces;
a second cylindrical member having a threaded portion on its inner surface, whereby said second cylindrical member threaded portion is threaded onto the outer surface threaded portion of the first cylindrical member with said inwardly extending housing portion lip between said first cylindrical member flange and said second cylindrical member;
wherein said inner surface threaded portion of the first cylindrical member is said housing portion inner thread.

15. The light fixture of claim 14, wherein said lock comprises:
a first lock for securing the lens relative to said first cylindrical member; and
a second lock for securing said second cylindrical member relative to said housing portion inwardly extending lip.

16. The light fixture of claim 1, further comprising:
a drive shaft rotatable about said orthogonal axis relative to said mounting arm, said drive shaft fixed on one end to said housing portion for rotation therewith and having a gear fixed on its other end; and
a worm extending axially in said mounting arm, said worm drivably engaging said drive shaft and having a drivable end exposed at said mounting arm second end.

17. The light fixture of claim 16,
wherein said mounting arm and said light housing have mating cylindrical portions mounted together, and said drive shaft has a diameter smaller than said cylindrical portion; and further comprising
a power line extending through said cylindrical portions in the radial space between said drive shaft and the inner walls of said cylindrical portions.

18. The light fixture of claim 17, wherein said light housing includes a cylindrical opening coaxial with said housing cylindrical portion, said cylindrical opening having a smaller diameter than said housing cylindrical portion, an arcuate slot is defined between said cylindrical opening and said housing, and said power line extends through said arcuate slot into said housing.

19. The light fixture of claim 1, wherein the support is a power supplying track, and further comprising a U-shaped mounting member with legs adapted to fit over the track, wherein the end of said legs are securable to said mounting arm first end.

20. The light fixture of claim 19, wherein said mounting member legs and said mounting arm first end include interengageable threaded portions.

21. The light fixture of claim 1, wherein the support is a power supplying track, and further comprising an insulated power line extending inside said fixture from said mounting arm first end where it is adapted to engage one side of a power circuit on said track to an insulated base in said light housing, wherein said light housing and mounting arm connect the insulated base to the other side of the power circuit on said track.

22. The light fixture of claim 1, wherein said mounting arm and said light housing have mating cylindrical portions mounted together, and further comprising scale indicators on said cylindrical portions indicative of the rotated position of the drive shaft around the orthogonal axis.

23. An adjustable lighting fixture for mounting on a support, comprising:
a mounting arm extending substantially axially between a first end adapted to be mounted on the support and a second end, said arm being adjustably rotatable about its axis with a first lock for securing said arm in a selected rotatable position;
a light housing including
a housing base mounted to said mounting arm adjacent said mounting arm second end for adjustable rotation about a second axis substantially orthogonal to said mounting arm axis, and
a housing portion for housing a light source, including
a light opening through which light from the light source may pass, and
a lens mounting adapted to selectively mount a lens in said light opening to direct light from the light source in a selected path, including
an inner thread inside said housing portion adapted to engage an outer thread of a lens, whereby said lens may be selectively threaded in said housing portion inner thread to selectively position the lens axially and angularly relative to said housing portion to direct light from the light source in a selected path; and
a lock for securing a lens in the selected threaded position relative to said housing portion,
wherein said housing portion and a mounted lens substantially enclose the light source, and said housing portion is removably securable in a fixed orientation relative to said housing base; and
a drive for adjustably rotating said housing base about the second axis, including
a drive shaft rotatable about said second axis relative to said mounting arm, said drive shaft fixed on one end to said housing portion for rotation therewith and having a gear fixed on its other end, and
a worm extending axially in said mounting arm, said worm drivably engaging said drive shaft and having a drivable end exposed at said mounting arm second end.

24. The light fixture of claim 23, wherein said housing portion and housing base are removably securable together by:
a first cylindrical lip around said housing base and a second cylindrical lip around said housing portion, one of said cylindrical lips being receivable in the other of said cylindrical lips;
a first annular groove in said first cylindrical lip and a second annular groove in said second cylindrical lip, wherein said annular grooves face one another and axially overlap when said housing portion is removably secured to said housing base;
a key connection between said cylindrical lips whereby said one cylindrical lip is receivable in said other cylindrical lip in only one angular orientation; and
a C-spring received in said grooves.

25. The light fixture of claim 24,wherein said C-spring is biased into one of the grooves when an axial force is applied between said housing portion and said housing base.

26. The light fixture of claim 23, wherein said housing portion and housing base are removably securable together by a key defining a selected orientation therebetween and a plurality of detent connections between said housing base and said housing portion.

27. The light fixture of claim 26, wherein:
said housing base includes a substantially flat base portion;
said housing portion is defined by walls extending substantially perpendicular to said base portion; and
when secured together, said base portion is positioned inside of said walls and said detent connections extend outwardly from the edge of said flat base portion toward said walls.

28. The light fixture of claim 27, wherein said flat base portion edge is irregularly shaped whereby said housing portion may be secured thereto in only one orientation.

29. The light fixture of claim 23, wherein said lens mounting further comprises:
a lip extending inwardly on the interior of said housing portion;
a first cylindrical member having a radially projecting flange on one side and a portion extending axially from the flange with threaded portions on its inner and outer surfaces;
a second cylindrical member having a threaded portion on its inner surface, whereby said second cylindrical member threaded portion is threaded onto the outer surface threaded portion of the first cylindrical member with said inwardly extending housing portion lip between said first cylindrical member flange and said second cylindrical member;
wherein said inner surface threaded portion of the first cylindrical member is said housing portion inner thread.

30. The light fixture of claim 29, wherein said lock comprises:
a first lock for securing the lens relative to said first cylindrical member; and
a second lock for securing said second cylindrical member relative to said housing portion inwardly extending lip.

31. The light fixture of claim 23, wherein the support is a power supplying track, and further comprising an insulated power line extending inside said fixture from said mounting arm first end where it is adapted to engage one side of a power circuit on said track to an insulated base in said light housing, wherein said light housing and mounting arm connect the insulated base to the other side of the power circuit on said track.

32. The light fixture of claim 23, wherein said mounting arm and said light housing have mating cylindrical portions mounted together, and further comprising scale indicators on said cylindrical portions indicative of the rotated position of the drive shaft around the orthogonal axis.
